(19) United States
(12) Patent Application Publication
(10) Pub. No.: US 2006/0268129 A1
(43) Pub. Date: Nov. 30, 2006

(54) Composite images

(76) Inventor: Yining Deng, San Mateo, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/138,222

(22) Filed: May 26, 2005

(51) Int. Cl. H04N 5/262

(52) U.S. Cl. 348/239

(57) ABSTRACT

The present application discloses a method, in a digital image capture device configured to enable the capture of a sequence of images for the generation of a wide angle composite image having an angular view greater than each image in the sequence of images, the method including, displaying a composite image formed from a portion of a frame of an image feed and a portion of at least one image from the sequence to generate a preview of a portion of the wide angle composite image having an angular view substantially equal to the current image feed.

### FIELD OF THE INVENTION

The present invention relates to capturing images for use in the creation of a composite image.

### BACKGROUND OF THE INVENTION

Digital cameras currently available offer various image capture modes which enhance the user's ability to take various styles of images with the camera. For example, many digital still cameras are adapted to take images in a rapid succession which can then be output as a video sequence. Certain cameras also have the ability to create panoramic images by stitching together two or more still images or images from a video sequence in such a way to create a single still image that depicts a scene of larger dimensions than a standard single frame image.

When taking panoramic images the aim of the camera needs to be changed between successive frames. For users, this process can be difficult, since the user is required to aim the camera such that the new image field overlaps the previous image field in a suitable manner for the images to be stitched together. In order to assist users in this task some digital cameras provide user interfaces which guide the users in the aiming process. One such interface involves displaying a user interface on the camera display which shows a portion of the previous image taken and overlays the current view of the camera over the previous image. This overlying image allows the user to more accurately align the current image being taken with the previous image.

Guiding user interfaces of this type can also assist in the process of stitching images together, by the camera or external software by:
1. helping to ensure the sequence is going in a single direction e.g., left to right
2. helping to minimise up and down drift;
3. helping to ensure sufficient overlap between consecutive images;
4. predetermining the overlapping portion of the two images and thereby improving accuracy and speed of image alignment determination during stitching.

The present inventors have determined that a guiding interface of the above type has several disadvantages. For example, it requires the user to do all the work in aligning the image and taking the new image. Furthermore, the display on many cameras is not sufficiently bright to clearly show images in well lit outdoor settings. As a result, it is often difficult for the user to display or align the images correctly which causes problems and errors for the stitching program.

### SUMMARY OF THE INVENTION

In a first aspect the present invention provides a method, for assisting in the capture of a sequence of images for the generation of a wide angle composite image having an angular view greater than each image in the sequence of images, the method including, displaying a composite image formed from a portion of a frame of an image feed and a portion of at least one image from the sequence to generate a preview of a portion of the wide angle composite image.

### BRIEF DESCRIPTION OF THE DRAWINGS

Embodiments of the present invention will now be described, by way of non-limiting example only, with reference to the accompanying drawings in which:

FIG. 1 depicts a schematic representation of a system configured to implement an embodiment of the present invention;

FIG. 2 depicts a flow chart of a method in accordance with a first embodiment of the present invention;

FIG. 3A illustrates a user interface of a first embodiment in which an image preview is displayed that includes a composite image formed from a predetermined portion of a previously captured image, in a situation in which the field of view of the current image feed overlaps a previous image by approximately 80 percent;

FIG. 3B illustrates the user interface of a first embodiment wherein the field of view of the current image feed overlaps a previous image by approximately 20 percent;

FIG. 3C illustrates a user interface of a first embodiment wherein the field of view of the current image feed does not overlap a previous image;

FIG. 4A illustrates a user interface of a second embodiment in which an image preview is displayed that includes a composite image having the same field of view as an image feed, in a situation in which the field of view of the current image feed overlaps a previous image by approximately 80 percent;

FIG. 4B illustrates the user interface of a second embodiment wherein the field of view of the current image feed overlaps a previous image by approximately 20 percent;

FIG. 4C illustrates a user interface of a second embodiment wherein the field of view of the current image feed does not overlap a previous image; and

FIG. 5 depicts a flow chart of a method in accordance with a further embodiment.

### DETAILED DESCRIPTION OF THE EMBODIMENTS

In a first embodiment there is provided an interface for a digital image capture device. The interface can be used with an image capture device such as a digital camera and assists a user of the device in taking wide field of view images. The interface does this by displaying a composite image to the user which forms part of the wide field of view image being taken, and which is formed from one or more images of the image sequence used to create the wide field of view images and the current image frame derived from an image feed from the image capture portion of the image capture device. The composite image shown on the display is updated in real time as the image frame from an image feed changes, and enables the user of the digital image capture device to aim the image capture device to capture the next image in the image sequence.

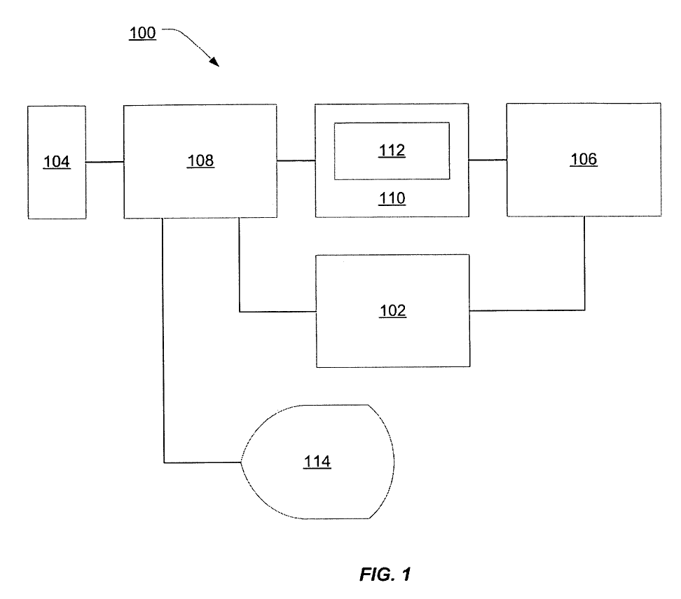

FIG. 1 depicts a block diagram representing functional components of a digital image capture device. The image capture device 100 is configured to capture one or more digital images. The image capture portion 202 comprises a charge-coupled device (CCD) and focusing optics (not shown) and is adapted to generate a digital representation of a scene. The image capture portion 102 generates an image feed comprising the output of the image capture portion. In order to create still frames from the image feed an actuation means 104 is provided. When the actuation means 104 is triggered at least one still frame is captured and stored in the image storage 106. The image capture device 100 additionally includes an embedded processing system 108 and a memory 110 configured to store a set of instructions (i.e. software or firmware) 112 to control the operation of the image capture device 100.

In one embodiment the image capture device 100 is in the form of a digital camera. However, it should be noted that the image capture system 100 can be a digital video camera, a webcam, or other digital image capture system. In such an embodiment the image capture device 100 also includes a display 114 configured to display captured images and/or an image feed from the image capture portion 102. At least part of the display portion 114 is also used to provide a user interface to allow a user to monitor and control the operation of the image capture device 100. The operation of an interface according to an embodiment will be described below.

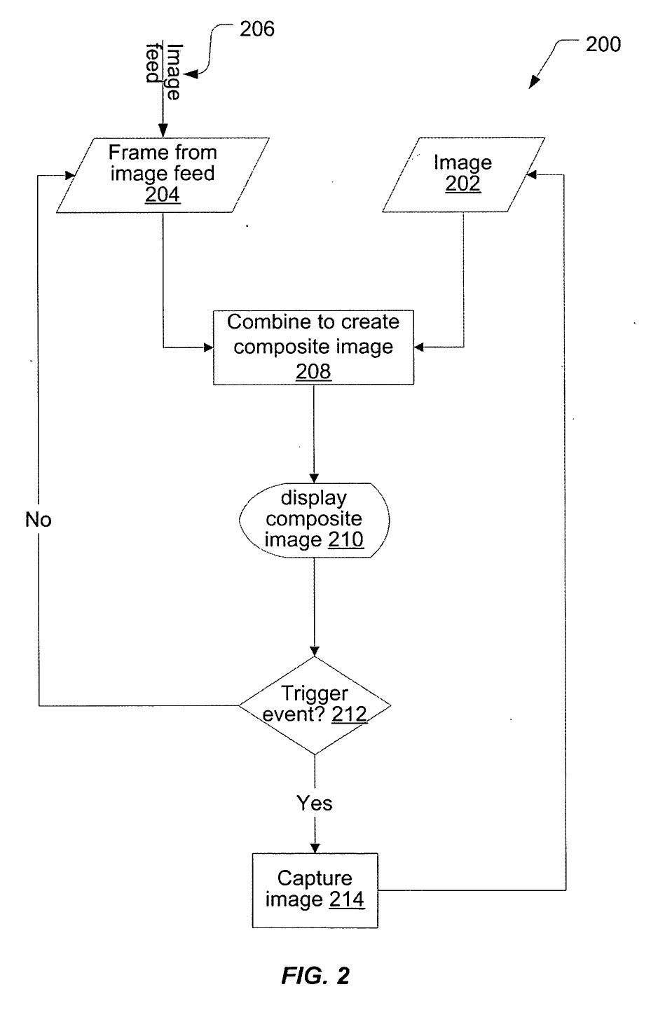

FIG. 2 is a flow chart depicting the process for the operation of digital image capture device as described above when taking a sequence of images that are to be formed into a wide-field image. To indicate that such an image is to be made the user selects the appropriate image capture mode using the camera interface.

The description of the process that follows begins after at least one image in the image sequence has been captured. Thus the process 200 begins with an image 202 and a frame from an image feed 204. The image 202 is a previously captured image in the image sequence from which a wide field image will be created. This image 202 can be the first image in the sequence or a later image. The image 202 could also be a composite or a portion of the wide field image which has already been stitched together.

The image frame 204 is derived from an image feed 206 and represents the current view of the image capture device. The image frame 204 represents the digital image that would be captured if the actuation means was activated at the present instant, and is typically the image that is shown in the display 114 of the image capture device. As will be appreciated the image feed changes as the scene which is being imaged changes, or the aim of the device or its settings change, e.g. focus or zoom level is adjusted. Accordingly the image frame 204 will be updated regularly.

The image 202 is combined with an image frame 204 from the image feed 206 of the image capture portion to create a composite image 208. The composite image 208 can be formed from a predetermined segment of the image 202, or the entire image 202. In one embodiment the right-most third of the image 202 is combined with the image frame 204 to create the composite image 208. As will be described in more detail below, the alignment and extent of overlap the image 202 and the image frame 204 is determined by the aim of the digital image capture device.

Stitching of the images 202 and 204 to form the composite image 208 can be by various methods that will be known to those skilled in the art. See for example Y. Deng and T. Zhang, “Generating Panorama Photos,” Proc. of SPIE Internet Multimedia Management Systems IV, vol. 5242, ITCOM, Orlando, September 2003, the contents of which are incorporated herein by reference.

By displaying the composite image the user is given a representation of what a portion of the final wide-field image will look like if the user was to take the next picture in the image sequence at that instant.

The composite image 206 is displayed at step 208, in real time, to the user in order to allow the user to adjust the aim of the digital image capture device to obtain the a desired stitching effect in the wide field image.

The display of the composite image at 208 is continually updated as the frame from the image feed 202 changes until a trigger event occurs at 212. A trigger event is any event that causes the digital image capture device to store an image to image storage. A trigger event can be a manual input performed by a user of image capture device, such as a user of a digital camera pressing the “shutter release” button or an automatic trigger event initiated by software application running in association with the image captured device. In one embodiment the image capture device is configured to detect the extent of overlap between the current image feed and previous image in a sequence of images to be combined into a wide field of view image. When the extent of overlap reaches a predetermined threshold the image capture device may be automatically triggered to capture an image. Other forms of an automatic triggering can also be used, for example, image capture may be triggered after the aim of the image capture device has been changed by a predetermined angular displacement since the last captured image.

Once and image is captured the image capture process 200 continues, with the most recently captured image taking on the role of the image 202 in the image capture process 200.

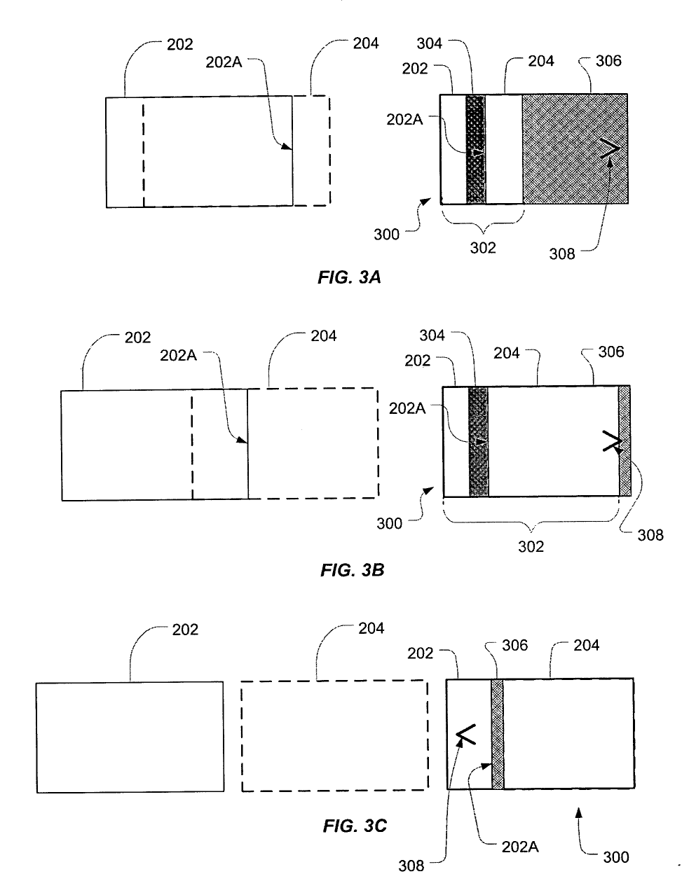

FIGS. 3(a) to 3(c) illustrate the user interface displayed to a user of the digital image capture device in another embodiment. FIGS. 3A to 3C show the user interface in a series of situations in which the extent of the overlap between an image 204 from the current image feed 206 and the previously captured image 202 204 is progressively increasing.

In this embodiment, the user interface of the image capture device is configured such that the composite image displayed thereon includes a fixed portion of the image 202. In the present example the images to be formed into a composite image are taken by panning the digital image capture device from left to right, and the image stitching algorithm being used to stich the individual images into a wide field image has determined that a 20% overlap between the images is optimum for stitching. Thus in this example the optimum alignment of consecutive frames of the image sequence has the rightmost 20% of the image 202 overlapping the leftmost 20% of the image feed frame 206.

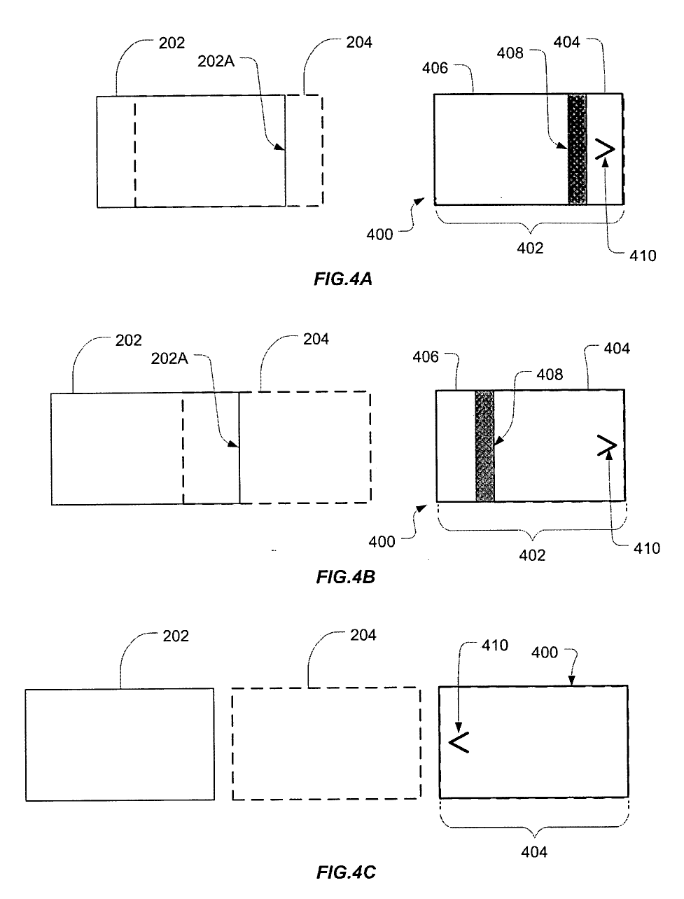

In FIGS. 4(a) to 4(c) the left hand side of the figures depict the alignment and extent of overlap of the frame from the current image feed 204 and the most recently taken image 202 in the image sequence from which a wide field image is to be formed. The right hand side of each figure depicts what a user of digital image capture device sees on a user interface 300 in accordance with an embodiment.

Turning now to FIG. 3(a), it can be seen that the current image frame 204 overlaps the image 202 by about 80%. The user interface 300 displays a composite image 302 comprising a stitched together portion of the feed image 204 and the most recent image 202. The stitching of images 202 and 204 need not use all of the overlapping portions of the images 202 and 204. In this example stitching of the images only occurs in the shaded stitching region 304 as illustrated.

In this embodiment the position of the right most edge 202a of the image 202 is held in a fixed position with respect to the user display 300. Since the images 202 and 204 overlap to such an extent the composite image 302 only includes about 20% of the image frame 204 and thus the composite image 302 takes up a relatively small portion of the display 300. The remaining portion of display 306 can be left blank to indicate to the user that it is possible to increase the level of overlap if desired.

In order to further guide the user of the digital image capture device to more optimally align the digital image capture device user interface 300 also includes an indicator to guide the user which direction to pan or tilt the camera in order to achieve a more optimal mosaicing result. In this embodiment an arrow 308 is displayed to a user to indicate which direction the digital image capture device should be panned in order to achieve a predetermined desirable overlap level between the image frame 204 and the previous image 202. In an alternative embodiment textual or other graphical means could be used to perform this function.

FIG. 3(b) shows, on its left hand side, the previous image frame 202, its alignment and its offset relative to the current image frame 204. As can be seen in FIG. 3(b) the two images 204 and 202 overlap by approximately 30%. In this case the user interface 300 displays a composite image 302 formed in the same manner as the composite image of FIG. 3(a). The composite image 302 is formed by mosaicing the previous image 202 with the image frame 204. The mosaiced image is displayed such that of the right most edge 202a of image 202 lies at a predetermined position in the image display portion of the interface 300. The image frame 204 and the previous image 202 are blended together a stitching region 304 as described above. Since the extent of overlap between the current image frame 400 and the previous image 202 is greater than 20% the composite image 302 does not extend the full way across the user interface 300. Accordingly, non-image region 306 is left at the right hand most edge of the user interface 300.

As in FIG. 3(b) the user interface 300 displays an arrow 308 indicating the suggested direction of panning of the digital image capture device in order to achieve the desired 20% overlap between the current image frame 204 and the previous image 202.

FIG. 3(c) shows the user interface 300 of the present embodiment in the case where the digital image capture device is aimed such that the current image feed 204 does not overlap the previous image 202. In this case it is not possible to make a composite image since the images 202 and 204 cannot be stitched together because there is no overlap. In this case the display 300 shows part of the previous image 202 on its left most sid. As in the previous FIGS. 3(a) and 3(b) the right most edge 202a of the previous image frame 202 is aligned at a position 20% of the way along the user interface display 300. The current image frame 204 is also partly displayed on the user interface at its right hand side and is aligned relative to the previous image frame 202 in accordance with their true alignments. A non image portion 306 is present between the portions of the previous image 202 and the current image frame 204.

The user interface 300 also indicates, using arrow 308 the direction in which the digital image capture device should be panned in order to achieve correctly aligned images for forming a mosaiced wide field image.

FIGS. 4(a) to 4(c) show an alternative embodiment of a user interface in the same three situations as FIGS. 3(a) to 3(c). Rather than displaying the composite image such that the positioning of the rightmost edge of the previous image 202 is at a constant position in the display, the embodiment of FIGS. 4(a) to 4(c) displays a composite image having the same field of view as the current image frame.

To illustrate this we turn to FIG. 4(a) which shows an interface 400. The interface 400 displays a composite image 402 which covers its entire surface. The right most portion 404 of the composite image 402 is formed of pixels derived from the corresponding position in the current image frame 204, and corresponds to the portion of the present image frame 204 which is not overlapped with the previous image 202. Conversely the left most portion 406 of the composite image frame 402 include pixels having values derived from the previous image frame 202. Between these two image portions 404 and 406 lies a blending region 408 in which the pixel values are determined according to a stitching algorithm as described above. Thus the view displayed on the user interface 400 is essentially corresponds to the current field of view of the digital image capture device, however the image displayed is a composite image including an overlapping portion of the previous image taken 202.

The arrow indicator 410 is displayed in the user interface 400 to indicate to the user to pan the digital image capture device to the right in order to achieve predetermined overlap between the current image frame 204 and the previous image frame 200.

FIG. 4(b) shows the user interface 400 in a situation where the extent of overlap between the current image frame 204 and the previous image 202 is approximately 30%. As described in connection with FIG. 4(a) the field of view of the display 400 is aligned with that of the current image feed. Accordingly the right most portion 404 of the composite image 402 displayed in the user interface 400 has pixel values derived from the corresponding portion of the current image feed 204. The left most portion 406 of the composite image 402 has pixel values derived from the corresponding portion of the previous image 202. As described above a blending region 408 exists between the left region 406 and the right region 404 of the composite image in which the pixel values are derived in accordance with a stitching algorithm. The user interface 400 also includes an indicator 410 of the direction in which the digital image capture device should be panned in order to achieve a desired level of overlap between the current image frame 204 and the previous image 202.

FIG. 4(c) shows the user interface 400 in the situation where the current image feed 204 does not overlap the previous image 202. In this situation the composite image cannot be formed as there is no overlap between the images 202 and 204 thus the user interface 400 shows only the image feed 204. In this case, the panning direction indicator 410 tells the user to pan the image capture device to the left in order to cause the current image field to overlap that of the previous image 202 in order to enable a mosaiced wide field image to be formed.

As will be appreciated by those skilled in the art the process of real time stitching of a current image feed with a previously stored image is potentially computationally intensive. In order to address this potential issue it may be necessary to downsample one or other of the current image feed or the previous image prior to forming the composite image for display in the user interface.

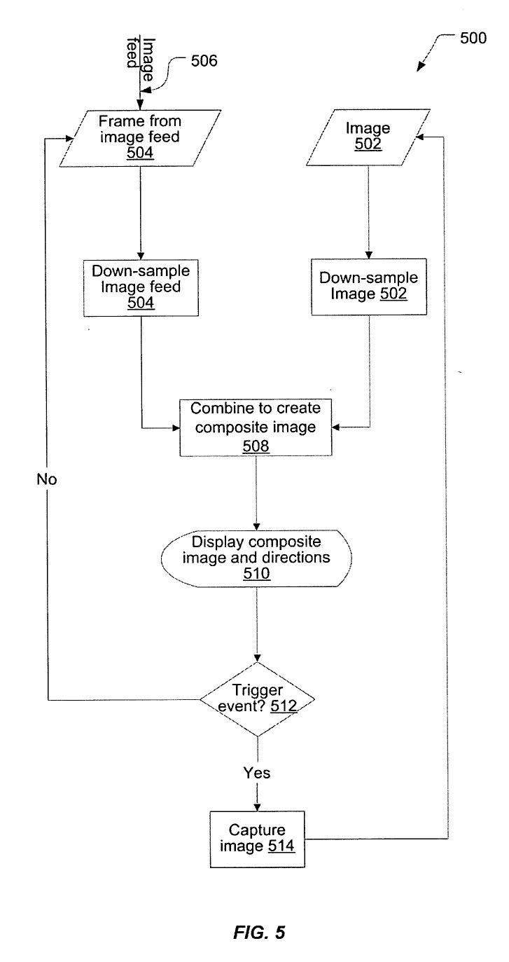

FIG. 5 depicts an alternative embodiment of a method of assisting a user of an image capture device when taking a series of images to create a composite wide field image. The method 500 has many steps in common with the method of FIG. 2, and common steps will not be described further. In the process 500 an image 502 and a frame 504 from an image feed 506 are downsampled in steps 508 and 510 respectively and then combined in step 512 to create a composite image for display in step 514 to a user of an image capture device. In the event of a trigger event 516 the current image feed is captured in step 518 and written to image storage and the process starts again with a new base image at step 502. If a trigger event does not occur at 516 the display is updated in real time as the frame from the image feed 504 is updated.

It will be understood that the invention disclosed and defined in this specification extends to all alternative combinations of two or more of the individual features mentioned or evident from the text or drawings. All of these different combinations constitute various alternative aspects of the invention.

In the exemplary embodiments described above a low resolution video feed from the image capture device is used in creating the stitched together preview image in real-time. This mode is applicable in the case where image capture device has two display pipelines, one for low-resolution image feed and one for high-resolution still image capture. In an alternative embodiment capture can be made in a “burst-mode” in which it is possible to capture a sequence of high-resolution images by pressing the shutter button once. Typically, burst-mode has lower frame rate (3-10 frames per second) compared to video (15-30 fps), or has a lower resolution (1-2 MP) compared to regular still capture (3-6 MP). As an alternative to down sampling the image feed prior to creating the composite preview image, as described in connection with FIG. 5, a variable resolution/frame rate burst mode can be employed. In this mode a low-resolution and high frame rate stage mimics the video mode with a high-resolution image being captured once a while to mimic the still image capture mode. For example, an image capture sequence the can be L L L L P P H W L L L L L, where L stands for low-resolution capture during which real-time panorama preview is displayed on the user interface, P stands for a pause waiting for the user to decide to capture the high resolution frame H, and W stands for the waiting time for high resolution frame capture and write out is completed.

In certain embodiments the user interface is configured to enable the user to select the manner in which the composite image is displayed on a display associated with the image capture device. In this regard the user interface enables a user to zoom-in on a particular portion of the composite image or to zoom-out to view a larger proportion of the composite image. In one embodiment user interface also allows the user to select which part of the composite image is displayed. In this regard, the user interface can provide controls to enable the user to scroll the display of the composite image in the vertical or horizontal directions.

With such embodiment, the user can make a detailed inspection the composite image to determine whether a particular feature has been included in a series of images and, if necessary, realign the image capture device to capture a new image. The image can be made to fill in any gaps in the image capture sequence or be the next in the image capture sequence.

Embodiments of the method are also applicable to variable resolution/frame rate video modes. This mode uses a video pipeline that can deliver images at different resolutions and frame rates. Unlike the burst-mode, which is originally derived from the still image pipeline, the image sequence is originally derived from a video pipeline. Embodiments of the method can also be applied to a combination of different image capture modes, such as still, burst, and video.

1. A method, for assisting in the capture of a sequence of images for the generation of a wide angle composite image having an angular view greater than each image in the sequence of images, the method including:
displaying a composite image formed from a portion of a frame of an image feed and a portion of at least one image from the sequence to generate a preview of a portion of the wide angle composite image.

2. The method as claimed in claim 1 which further includes capturing an image from an image feed upon the occurrence of an image trigger event.

3. The method of claim 2 wherein the image trigger event is selected from one of the following events:
a user input;
the composite image includes a predetermined proportion of the frame of the image feed;
the composite image includes a predetermined proportion of an image from the sequence of images.

4. The method of claim 1 wherein the method includes displaying image capture directions to a user simultaneously with the composite image.

5. The method of claim 1 which includes, generating the composite image for display using “representations” of the frame of an image feed and the image from the sequence such that displayed composite image has lower resolution than the wide angle composite image.

6. The method of clam 5 which includes down sampling at least one of the frame of the image feed and the image from the sequence, prior to generating the displayed composite image.

7. A user interface for use with a digital image capture device and for use during the capture of a sequence of images to be used for the generation of a wide angle composite image, the user interface including a image display portion displaying a composite image formed from a portion of a frame of an image feed of the image capture device and a portion of at least one image from the sequence to generate wherein the composite image represents a portion of the wide angle composite image.

8. The user interface of claim 7 includes a user instruction portion configured to display at least one operating instruction to the user.

9. The user interface of claim 8 wherein an operating instruction displayed in the user instruction portion relates to one of more of the following;
an instruction to initiate image capture;
an instruction to end image capture;
an instruction to adjust the aim of the image capture device;
an instruction how to adjust the aim of the image capture device;
an instruction to maintain the aim of the image capture device;
the status of the image sequence being captured.

10. The user interface of claim 7 wherein the composite image displayed in the image display portion has a lower resolution than the images of the sequence of images captured by the image capture device.

11. A digital image capture device including user interface for use during the capture of a sequence of images to be used for the generation of a wide angle composite image, the user interface including a image display portion displaying a composite image formed from a portion of a frame of an image feed of the image capture device and a portion of at least one image from the sequence to generate wherein the composite image represents a portion of the wide angle composite.

12. The digital image capture device of claim 11 wherein the user interface includes a user instruction portion configured to display at least one operating instruction to the user.

13. The digital image capture device of claim 11 wherein an operating instruction displayed in the user instruction portion relates to one of more of the following;
an instruction to initiate image capture;
an instruction to end image capture;
an instruction to adjust the aim of the image capture device;
an instruction how to adjust the aim of the image capture device;
an instruction to maintain the aim of the image capture device;
the status of the image sequence being captured.

14. The digital image capture device of claim 11 wherein the user interface includes the composite image displayed in the image display portion has a lower resolution than the images of the sequence of images captured by the image capture device.

15. The digital image capture device of claim 11 wherein the digital image capture device is a digital still camera.

16. The digital image capture device of claim 11 wherein the digital image capture device is a digital video camera.

17. An image processing software application configured to cause a processing device to generate, for display, a composite image representing a portion of a wide angle image formed from a sequence of images, said image processing software application causing the processing device to generate a composite image from a portion of a frame of an image feed and a portion of at least one image of the sequence.

18. The image processing software application of clam 17 configured to cause a processing device to downsample at least one of, the frame of the image feed, and the image from the sequence, prior to generating the composite image.

19. The image processing software application of clam 17 configured to cause a processing device to cause an image capture device to capture an image of the sequence of images upon the occurrence of an image trigger event.

20. The image processing software application of clam 19 wherein the image trigger event is selected from one of the following events:
a user input;
the composite image includes a predetermined proportion of the frame of the image feed;
the composite image includes a predetermined proportion of an image from the sequence of images.
